(19) United States
(12) Patent Application Publication
(10) Pub. No.: US 2019/0179526 A1
(43) Pub. Date: Jun. 13, 2019

(54) CONTROLLING PRESENTATION OF MEDIA CONTENT AT AN ELECTRONIC DEVICE BASED ON CIRCULAR MOTION PATTERN GESTURES

(71) Applicant: Howard Yellen, San Francisco, CA (US)

(72) Inventor: Howard Yellen, San Francisco, CA (US)

(21) Appl. No.: 15/840,627

(22) Filed: Dec. 13, 2017

(51) Int. Cl. G06F 3/0488; G06F 3/01; G06F 3/041

(52) U.S. Cl. CPC G06F 3/04883; G06F 3/017; G06F 3/03545; G06F 3/0416; G06F 3/0412

(57) ABSTRACT

Disclosed is a user interaction technique for controlling presentation of digital media content at an electronic device based on user input gestures that follow a circular motion pattern such as a spiral motion pattern. Such a user interaction may, for example, cause the performance of a scrubbing operation to move from one position to another in the digital media content at a variable scrubbing rate. In such an embodiment, the variable scrubbing rate at any given time during the user input gesture may be based on a characteristic of the circular motion pattern.

### TECHNICAL FIELD

The present disclosure generally relates to user interface technology for electronic devices.

### BACKGROUND

Digital media content is becoming increasingly more prevalent. There exist a number of different user interface mechanisms designed to allow a user to navigate such content via electronic devices such as personal computers, mobile phones, tablet devices, televisions, and the like. For example, a user may wish to control the presentation of a piece of digital media content such as an audio file or a video file by moving from a first position to a second position in the piece of digital media content. This user interaction is sometimes referred to as “scrubbing.”

Existing user interface techniques for scrubbing to navigate through a piece of digital media content are often awkward, inefficient, and inaccurate. For example, as electronic devices with touch screen displays have gained popularity, a common user interface technique for performing a scrubbing operation has emerged that involves the user sliding his or her finger across the display to move a cursor along a progress bar. In such a user interface, the progress bar is representative of a size or length of the media content with the cursor's location along the progress bar representative of a position in the media content currently being presented. A problem with such a user interface is that the progress bar is often dimensioned based on the geometric constraints of the display through which it is presented. In other words, due to the geometric constraints of a display, a progress bar interface element for a two-minute song may have the same dimensions as the progress bar element for a two-hour movie. Another problem with such a user interface is that the aforementioned scale issues can make it difficult for a user to select a specific location. Small motions introduced when the user lifts a finger off of a touch screen display often cause the progress bar to move forward or backward away from the user's intended location. Such problems with existing user interface solutions in inevitably lead to frustration on the part of the user when trying to accurately move from one position to another in a piece of media content.

### BRIEF DESCRIPTION OF THE DRAWINGS

FIG. 1 a block diagram illustrating an example of a processing system in which at least some operations described herein can be implemented;

FIG. 2 illustrates an example circular motion pattern associated with the disclosed user interaction technique;

FIG. 3 illustrates an example of an actual tracked path of a point of interaction that is recognizable as a circular motion pattern;

FIG. 4 illustrates how geometric features of a circular motion pattern are implied based on an tracked motion of a point of interaction;

FIG. 5 illustrates how a circular motion pattern can change over time during a user input gesture;

FIG. 6A illustrates how a radial distance varies at different points along an example circular motion pattern;

FIG. 6B depicts a set of circles that may be inferred based on a circular motion pattern;

FIG. 6C shows an example circular motion pattern relative to the set of inferred circles of FIG. 6B;

FIG. 6D shows a graph describing an example relationship between a scrubbing operation rate and a radius of an circle inferred based on a circular motion pattern;

FIG. 7 illustrates how a tracked point of interaction may complete one or more revolutions about an implied origin of a circular motion pattern;

FIG. 8 illustrates how a curvature of a path of motion of a point of interaction varies along a circular motion pattern;

FIG. 9 illustrates an example implementation of the disclosed user interaction technique to control presentation of a video at a touch screen device;

FIG. 10 illustrates an example implementation of the disclosed user interaction technique to control presentation of a document at a touch screen device;

FIG. 11 illustrates an example implementation of the disclosed user interaction technique to control presentation of audio at a touch screen device via an interactive graphical user interface element;

FIG. 12 illustrates an example implementation of the disclosed user interaction technique to control presentation of a video in which the user input gesture is made in the air;

FIG. 13 illustrates an example implementation of the disclosed user interaction technique to control presentation of a video using an augmented reality or virtual reality device; and

FIG. 14 is a flow chart of an example process for controlling presentation of digital media content at an electronic device using the disclosed user interaction technique.

### DETAILED DESCRIPTION

### Overview

Introduced herein is an intuitive user interaction technique for controlling presentation of digital media content at an electronic device that addresses the problems associated with existing user interface mechanisms. Specifically, the disclosed user interaction technique involves user inputs in the form of circular motion pattern gestures to control a scrubbing operation or other types of media control operations. The user can perform the disclosed user interaction technique, for example, by moving a finger or stylus across a touch screen display or by moving a finger or controller device freely in the air, to control the presentation of digital media content. Certain characteristics of the circular motion pattern input by the user can govern aspects of the control of the digital media content. For example, in some embodiments, a scrubbing operation can be performed based on the circular motion pattern input by the user wherein certain variable parameters such as the scrubbing rate of the scrubbing operation are based on the geometry of the circular motion pattern.

### Example Electronic Device

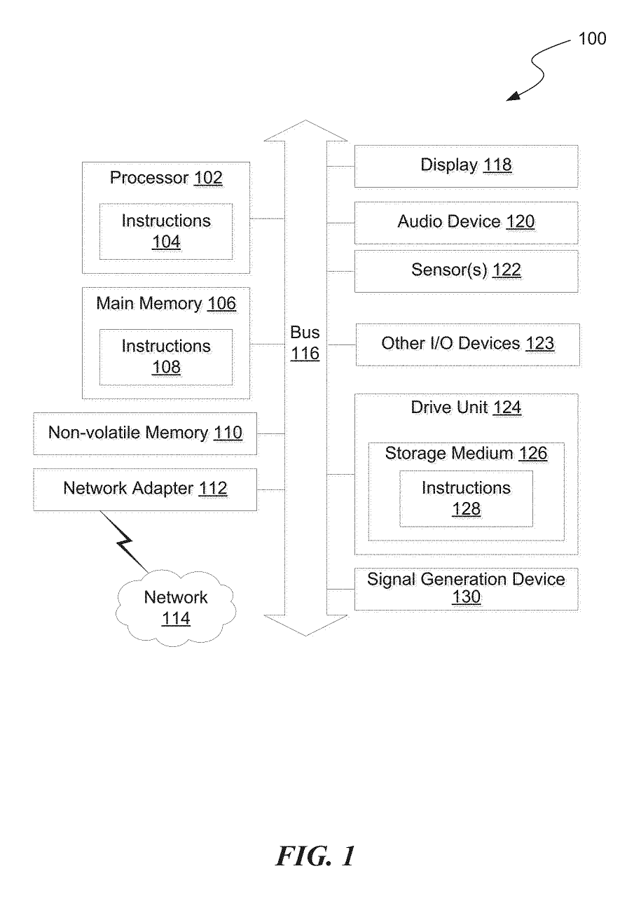

FIG. 1 shows a block diagram illustrating an example of a processing system 100 in which at least some operations described herein can be implemented. Various components of the processing system 100 depicted in FIG. 1 may be included in an electronic device utilized to perform one or more aspects of the user interaction technique described herein.

An electronic device in this context can include any type of device capable of presenting digital media content. Example electronic devices can include personal computers, tablet computers (e.g., Apple iPad™), mobile phones (e.g., Apple iPhone™), wearable devices (e.g., Apple Watch™), augmented reality devices (e.g., Google Glass™), virtual reality devices (e.g., Oculus Rift), televisions, game consoles (e.g., Sony Playstation™), voice-controlled personal assistant devices (e.g., Amazon Echo™), and the like. Digital media content in this context can generally include any type of digital or electronic content that can be viewed or accessed via an electronic device. The digital media content can include audio files, video files, image files, document files (e.g., Adobe Acrobat™ .pdf files, Microsoft Word™ .doc files, etc.), presentation slides (e.g., Microsoft Powerpoint™ .ppt files), web content (e.g., web pages), and the like.

The processing system 100 may include one or more central processing units (“processors”) 102, main memory 106, non-volatile memory 110, network adapter 112 (e.g., network interfaces), a display 118, an audio device 120, sensors 122, and other input/output devices 123, drive unit 124 including a storage medium 126, and signal generation device 130 that are communicatively connected to a bus 116. The bus 116 is illustrated as an abstraction that represents any one or more separate physical buses, point to point connections, or both connected by appropriate bridges, adapters, or controllers. The bus 116, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the processing system 100 operates as a standalone electronic device, although the processing system 100 may also be connected (e.g., wired or wirelessly) to other machines in any configuration capable of executing a set of instructions (sequential or otherwise) that specify actions to be taken by the processing system.

While the main memory 106, non-volatile memory 110, and storage medium 126 (also called a “machine-readable medium”) are shown to be a single medium, the term “machine-readable medium” and “storage medium” should be taken to include a single medium or multiple media (e.g., a centralized or distributed database, and/or associated caches and servers) that store one or more sets of instructions 128. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure may be implemented as part of an operating system or a specific application, component, program, object, module, or sequence of instructions referred to as “computer programs.” The computer programs typically comprise one or more instructions (e.g., instructions 104, 108, 128) set at various times in various memory and storage devices in a computer, and that, when read and executed by one or more processing units or processors 102, cause the processing system 100 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include recordable type media such as volatile and non-volatile memory devices 110, floppy and other removable disks, hard disk drives, optical disks (e.g., Compact Disk Read-Only Memory (CD ROMS), Digital Versatile Disks (DVDs)), and transmission type media such as digital and analog communication links.

The network adapter 112 enables the processing system 100 to mediate data in a network 114 with an entity that is external to the processing system 100 through any known and/or convenient communications protocol supported by the processing system 100 and the external entity. The network adapter 112 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 112 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including, for example, the access and operation rights of an object by an individual, a machine, and/or an application, and the circumstances under which the permission rights stand.

The display 118 may utilize liquid crystal display (LCD) technology, light-emitting diode (LED) technology, organic LED (OLED) technology, or any other display technology configured to produce a visual output to a user. The visual output may be in the form of graphics, text, icons, video, images, and any combination thereof (collectively termed “graphics”). In some embodiments, the visual output may correspond to interactive elements implemented as part of a graphical user interface (GUI).

In some embodiments, a display 118 may be configured as a user input device, for example, in the form of a touch-sensitive display system. A touch-sensitive display system may have a touch-sensitive surface and a sensor (or set of sensors) that accepts input from the user based on haptic and/or tactile contact. The touch-sensitive display system (along with any associated modules and/or sets of instructions 104, 108, 128) may detect contact (and any movement or breaking of the contact) on the touch screen and convert the detected contact into interaction with presented digital media content. In some embodiments, the contact may be converted into user interaction with GUI objects (e.g., interactive soft keys or other graphical interface mechanism) that are displayed on the display 118. In some embodiments, the display system may be configured to detect close proximity or near contact (e.g., ˜1 millimeter) (and any movement or breaking of the contact) between the screen of the display 118 and an object such as the user's finger. In an exemplary embodiment, a point of contact (or point of near contact) between a touch screen and the user corresponds to a finger of the user or some other object such as a stylus.

A touch-sensitive display system may be associated with a contact/motion module and/or sets of instructions 104, 108, 128 for detecting contact (or near contact) between the touch-sensitive screen and other objects. A contact/motion module may include various software components for performing various operations related to detection of contact, such as determining if contact has occurred, determining if there is movement of the contact, tracking the movement of the contact across display screen, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module may be employed to detect contact via other touch-sensitive input devices not associated with a display such as a touch pad.

In some embodiments, the display 118 may be configured as a tactile output device. Such a display may include systems configured to provide haptic feedback to a user interacting with the device through the use of various types of tactile stimuli. For example, a haptic feedback display may output mechanical vibrations, ultrasonic vibrations, and or electrical signals to provide haptic feedback to a user via the otherwise smooth surface of the display 118.

In some embodiments, the display 118 may be configured as a projector display to project a visual output onto a surface such as a wall or a screen.

In some embodiments, the display 118 may be configured as an augmented reality (AR) or virtual reality (VR) display. An AR display can deliver to a user a live direct or indirect view of the surrounding physical environment that is augmented (or supplemented) by computer-generated sensory inputs such as sound, video, graphics or GPS data. For example, visual outputs can be displayed to a user via a transparent display while the user is viewing the surrounding physical environment. Examples of AR display devices include handheld display devices such as smart phones and tablet devices, head mounted display devices (e.g., Microsoft HoloLens™, Google Glass™), virtual retinal display devices, heads up display (HUD) devices (e.g., in vehicles), and the like.

An audio device 120, including one or more speakers and/or microphones, may provide an audio interface between an electronic device implementing processing system 100 and the environment surrounding the electronic device, including a user. Audio circuitry associated with the audio device 120 may receive audio data from other components of the processing system 100, convert the audio data into an electrical signal, and transmit the electrical signal to one or more speakers associated with the audio device 120. The one or more speakers may convert the electrical signal to human-audible sound waves. Audio circuitry may also receive electrical signals converted by a microphone from sound waves. The audio circuitry may convert the received electrical signals to audio data and transmits the audio data to the other components of the processing system 100 for processing. In some embodiments, audio data may be retrieved from and/or transmitted to memory 106.

Sensors 122 may include optical sensors, proximity sensors, location/motion sensors, pressure sensors (e.g., barometers) or any other types of sensing devices.

Optical sensors may implement any type of optical sensing technology such as a charge-coupled device (CCD) or complementary metal-oxide semiconductor (CMOS) phototransistors. An optical sensor receives light from the environment, projected through one or more lenses (the combination of optical sensor and lens herein referred to as a “camera” or “image capture device”) and converts the light to data representing an image. In conjunction with an imaging module and/or sets of instructions 104, 108, 128, the optical sensor may capture still images and/or video of the surrounding environment. In some embodiments, an electronic device may be configured with two or more cameras, to capture depth information (e.g., stereoscopic vision).

Proximity sensors may generally implement any type of remote sensing technology for proximity detection and range measurement such as radar, sonar, and light illuminated detection and ranging (LIDAR).

In some embodiments, an electronic device implementing computer vision techniques may be configured to perform such remote sensing operations using the optical sensors of a camera. For example, a computer vision module and/or set of instructions 104, 108, 128 may be configured to receive images (including video) of the surrounding environment from an image capture device, identify (and in some cases recognize objects) captured in the received images, and track the motion of the identified objects captured in the images.

Location and/or motion sensors may implement any type of technology for measuring and reporting the position, orientation, velocity, and acceleration of an electronic device. For example, motion sensors may include a combination of one or more gyroscopes and accelerometers. In some embodiments, such components are organized as inertial measurement units (IMU).

For location sensing, a global positioning system (GPS) receiver can be used to receive signals from GPS satellites in orbit around the Earth, calculate a distance to each of the GPS satellites (through the use of GPS software), and thereby pinpoint a current global position of an electronic device with the GPS receiver.

The processing system 100 may further include any other types of input and/or output devices 123 not discussed above. For example, input/output devices 123 may include user input peripherals such as keyboards, mice, touch pads, etc. Input devices 123 may also include output peripherals such as printers (including 3D printers).

As indicated above, the techniques introduced here may be implemented by, for example, programmable circuitry (e.g., one or more microprocessors), programmed with software and/or firmware, entirely in special-purpose hardwired (i.e., non-programmable) circuitry, or in a combination of such forms. Special-purpose circuitry can be in the form of, for example, one or more application-specific integrated circuits (ASICs), programmable logic devices (PLDs), field-programmable gate arrays (FPGAs), etc.

Note that any of the embodiments described above can be combined with another embodiment, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

### User Interaction Based on Circular Motion Patterns

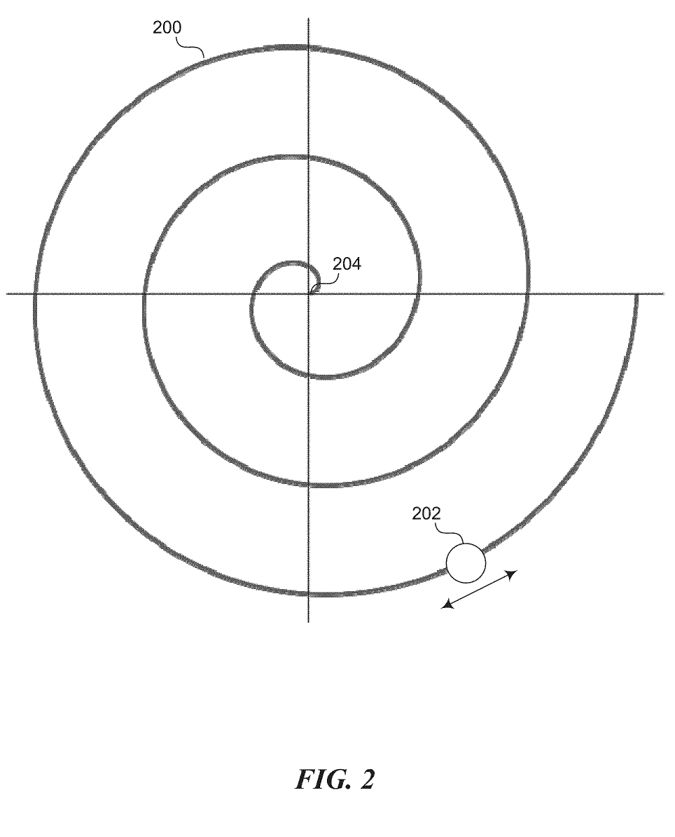

FIG. 2 shows an example circular motion pattern 200 that illustrates certain embodiments of the introduced user interaction technique at a high level. Specifically, the circular motion pattern depicted in FIG. 2 is of a “spiral motion pattern.” In this context, the term “spiral” is understood to include any type of circular pattern that includes a gradually widening (or tightening) curve. In other words, the term “circular motion pattern,” as used in this disclosure, is understood to include spiral motion patterns as a specific type of circular motion pattern. A circular motion pattern would also include a motion pattern that revolves about an inferred origin point at a constant radial distance. Accordingly, a circular motion pattern can be understood to be based on the motion of some point of reference such that the tracked path of the point of reference generally forms some type of circular pattern including spiral patterns and/or spiral-like patterns.

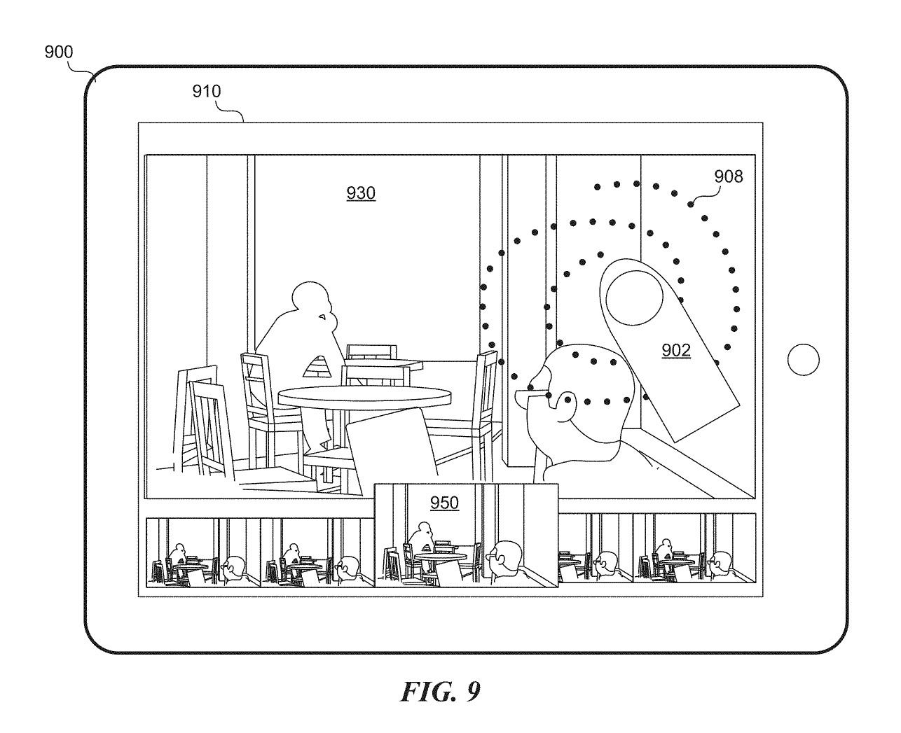

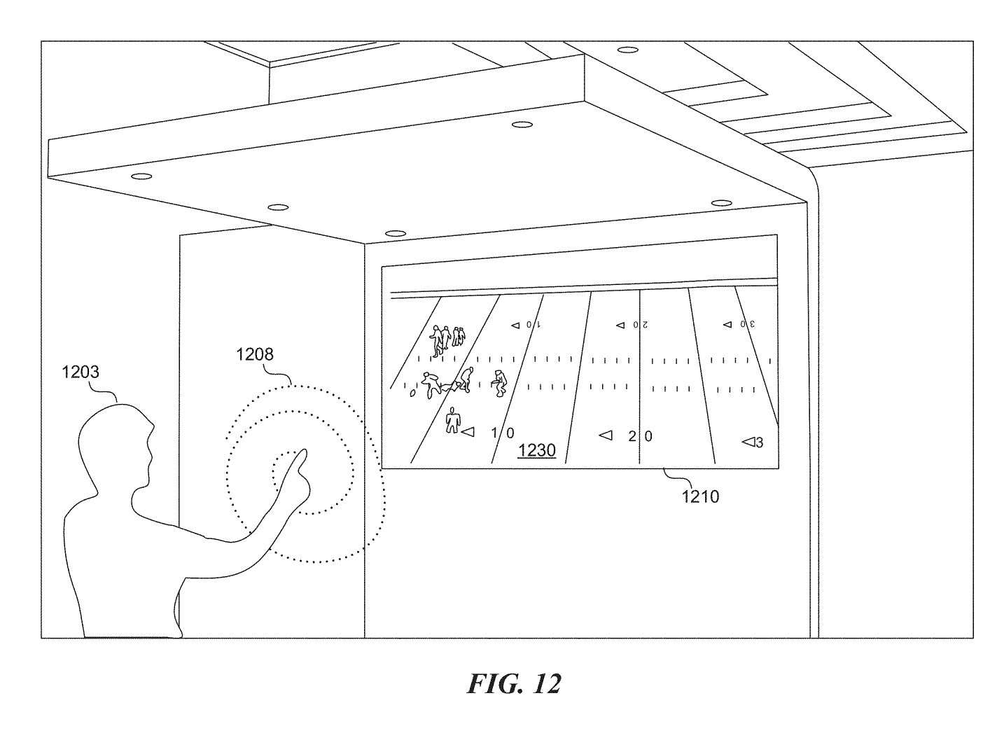

As shown in FIG. 2, a point of interaction 202 (i.e., point of reference) moving in a circular motion pattern 200 can be interpreted as a user input to control presentation of digital media content at an electronic device. The point of interaction 202 in this context may correspond with any type of interaction between the user and electronic device implementing the disclosed technique. In some embodiments, the point of interaction 202 represents a point of contact between an object such as the user's finger or a stylus and a touch-sensitive input device (e.g., a touch screen display or touch pad) of the electronic device. FIG. 9. shows an example implementation of the disclosed technique via a tablet device with a touch screen display. In other embodiments, the point of interaction 202 may represent the tracked position of an object in space (i.e., not in contact with the electronic device. For example, a user may use his or her finger or some type of motion sensing device (e.g., a Nintendo Wii™ remote) to “draw” the circular motion pattern in the air. FIG. 12. shows an example implementation of the disclosed technique in which the circular motion pattern is drawn in the air.

As mentioned, the motion of the point of interaction 202 forming the circular motion pattern 200 can be detected, analyzed, and interpreted as a user input to control presentation of digital media content at an electronic device. For example, an electronic device can be configured to perform a “scrubbing” operation in response to detecting a point of interaction 202 moving in a circular motion pattern 202. For example, a circular motion pattern moving inwards in one direction with a gradually tightening curve may cause a scrubbing operation in one direction, while motion along a similar circular pattern moving outwards with a gradually widening curve may cause a scrubbing operation in the opposite direction. Alternatively, or in addition, the direction of a scrubbing operation may be based on the direction of the circular motion pattern regardless of whether the motion is moving inwards with a tightening curve or outwards with a widening curve. For example, in some embodiments, any clockwise motion about an implied origin may case a scrubbing operation in one direction while counter-clockwise motion about an implied origin may case a scrubbing operation in the opposite direction.

As previously mentioned, “scrubbing” may refer to a navigating operation to move from one point to another point in a piece of digital media content or a set of multiple pieces of digital media content. For example, digital media content such as audio files or video files have a linear arrangement based on a temporal duration. In other words, the content item has a beginning position, an end position, and multiple positions in between that make up the duration of the content. Scrubbing in this context may refer to an operation based on a user input to move to the different positions to control the current playback of the audio or video file. The currently disclosed technique is not limited to audio or video files. Consider, for example, a document such as a .pdf file that includes multiple pages. For such a file, the “scrubbing operation,” may instead refer to a user input to move through the multiple pages of the document. The same type of user interaction technique can similarly be applied to navigating through other types of digital media content or collections of digital media content. For example, the disclosed user interaction technique can be used to navigate through an album of digital images, a graphical listing of files in a directory, a graphical listing of contacts in an digital address book, application icons on a GUI desktop, a graphical listing of stored messages in a messaging application, or any other type of digital media content. Further, the term “scrubbing” is used herein for illustrative clarity to refer to any type of user interaction for navigating through a piece of digital media content or collection of digital media content, however such operations may also be known by other terms such as “scrolling,” “seeking,” “searching,” “fast-forwarding,” “re-winding,” “zooming,” and the like. For the purposes, of this disclosure, the term “scrubbing,” shall be understood to encompass all such other terms for navigating through a piece of digital media content or collection of digital media content.

For illustrative clarity, the user interaction technique disclosed herein will be described in the context of a scrubbing operation as described above. However, a person of ordinary skill in the art will recognize that the user interaction technique can similarly be applied to any other type of operation to control presentation of digital media content. For example, an electronic device may be configured to adjust a variable parameter associated with the presentation of digital media content in response to detecting a point of interaction 202 moving in a circular motion pattern 202. Variable parameters associated with the presentation of digital media content will depend on the type of content presented, but can include audio output parameters (e.g., volume, balance, bass, treble, etc.), visual output parameters (e.g., color, tint, white balance, sharpness, zoom, etc.), and the like.

A notable feature of the presently disclosed user interaction technique is that the geometry of the circular motion pattern 200 can vary the way in an operation such as a scrubbing operation is performed. For example, in some embodiments, a scrubbing rate may increase or decrease as the point of interaction curves inward towards (or outward away form) a particular point of reference such as the origin 204 of the circular motion pattern 200. Consider an illustrative example involving a user listening to a song using a touch screen device such as a smart phone. Instead of sliding a cursor across a progress bar (e.g., as previously described) to perform a scrubbing operation at a constant rate, a user may instead begin running his or her finger over the surface of the touch screen in a spiral-like pattern similar to the circular motion pattern 200 depicted in FIG. 2. As the curvature of the user's touch motion tightens towards an implied origin point of the spiral, the rate of the scrubbing operation may increase (or decrease). In other words, as the user's touch motion tightens towards the implied origin point of the spiral, smaller movements of the user's finger will result in greater changes in the position of audio playback. Similarly, as the user's touch motion widens away from the implied origin point of the spiral, the rate of the scrubbing operation (in the opposite direction) may increase (or decrease). Using this technique, a user may quickly advance to a particular point in a long audio file such as an audiobook by tightening the geometry of the circular motion pattern input via the touch screen. Further, as the user approaches the point in the audio book they want to listen to they may widen the curvature of the spiral away from the implied origin to reduce the scrubbing rate for finer scrubbing. Using this technique, after quickly advancing to a rough position in a long audio file, the user can reduce the scrubbing rate to by widening the curvature of the spiral away from the implied origin to move to a precise position.

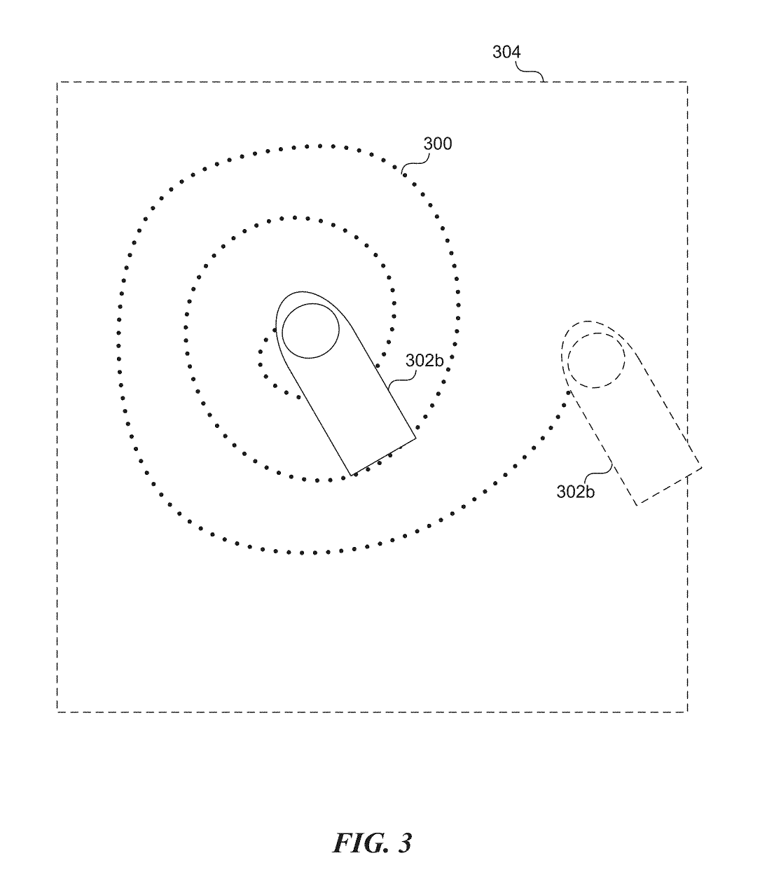

It is important to note that the circular motion pattern 200 depicted in FIG. 2 represents an idealized spiral pattern. For example, the circular pattern 200 depicted in FIG. 2 is based on an Archimedean spiral described by the equation: r=αθ^{1/n}, wherein r is the radial distance from the origin, θ is the polar angle, and n is a constant describing how tightly the spiral is wrapped. The circular motion pattern used to implement the techniques described herein may similarly be based on other types of spirals such as hyperbolic spiral, a logarithmic spiral, Fibonacci spiral, and the like. Regardless, in practice, the tracked motion of an object (e.g., a finger, stylus, etc.) forming the user's input will likely not follow such a mathematically precise path, particularly, if the user is not provided any visual interface guide along which to trace their motion. For example, FIG. 3 shows an example of an actual tracked path of a user's finger over a surface of a display 304 from a first position 302a, to a second position 302b. As is evident from FIG. 3, the actual tracked path 300 may exhibit a spiral or spiral-like pattern even if it does not conform with the path of a mathematical spiral.

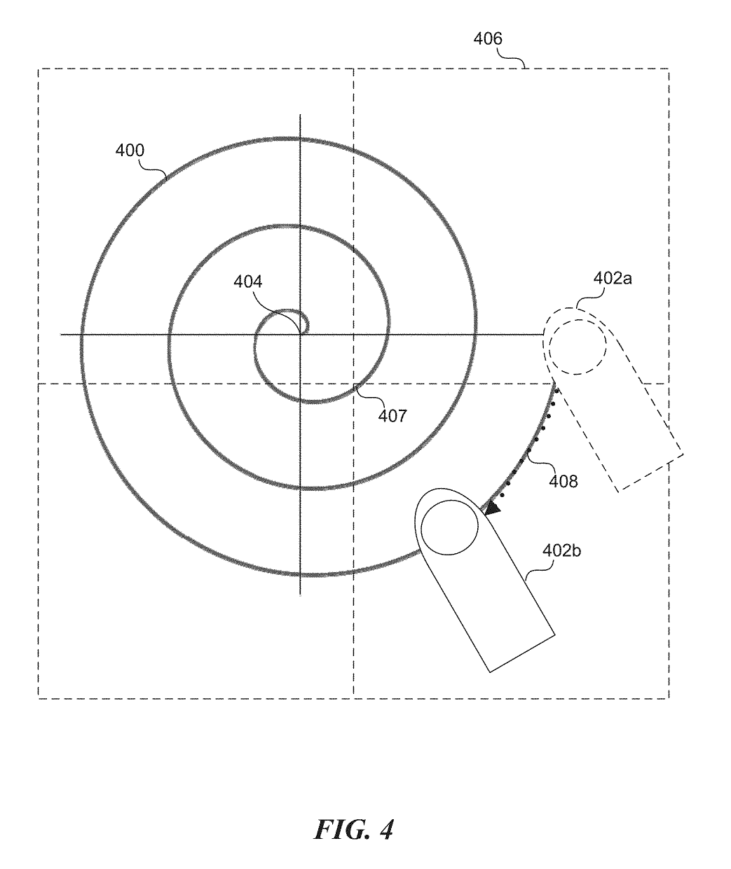

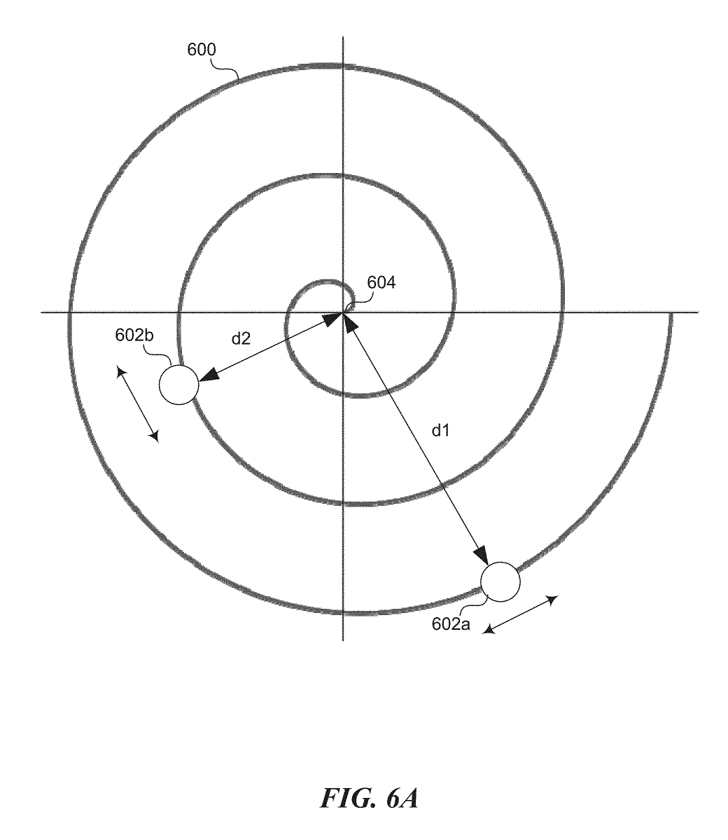

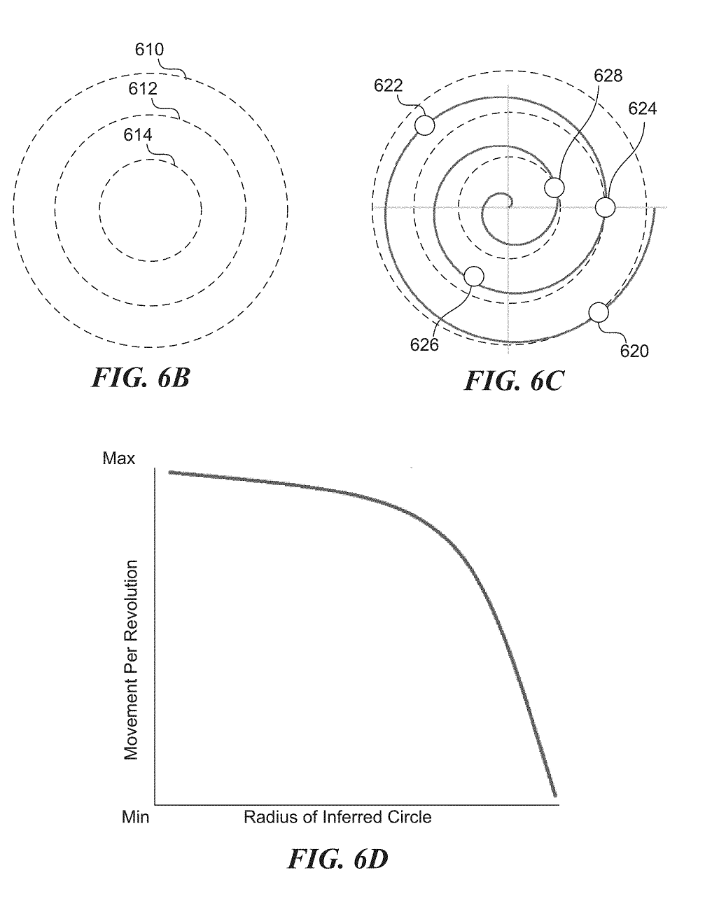

To account for irregularities in the actual tracked motion of an object (e.g., a user's finger) certain embodiments of the disclosed technique may involve analyzing the tracked motion at a various points to approximate or imply a user's intent, for example, based on a heuristic classifier. For example, by tracking the motion of a user's finger, an interface system may imply certain geometric features such as an origin or axis of a spiral. Consider, for example, the scenario depicted in FIG. 4. As shown in FIG. 4, a user has moved his or her finger over the surface of a touch screen display 406 from a first position 402a to a second position 402b. The positions of the user's finger may be calculated relative to a point of reference, such as a the geometric center 407 of the display screen 406. The actual tracked motion 408 of the user's finger has not yet formed a spiral, however, having analyzed the curvature of the actual tracked motion 408, the system may recognize the user's input as a circular motion pattern (e.g., specifically a spiral motion pattern) according to an implied spiral 400 with an implied origin point 404. Similarly, as will be described with respect to FIGS. 6B-6D, the system may interpret the motion as relative to an implied circle with an implied origin point. Note that the scenario depicted in FIG. 4 shows the user's finger having traveled a particular distance along the actual tracked path 408. In some embodiments, the system may be configured to recognize a user's input as a circular motion pattern and imply certain geometry of the circular motion pattern nearly instantaneously as the user begins to provide the input. For example, the user interaction technique may be context dependent. In other words, the system may be more inclined to recognize motion by an object (e.g., a user's finger) as indicative of a scrubbing input when certain digital media content, such as an audio file or video file, is being presented.

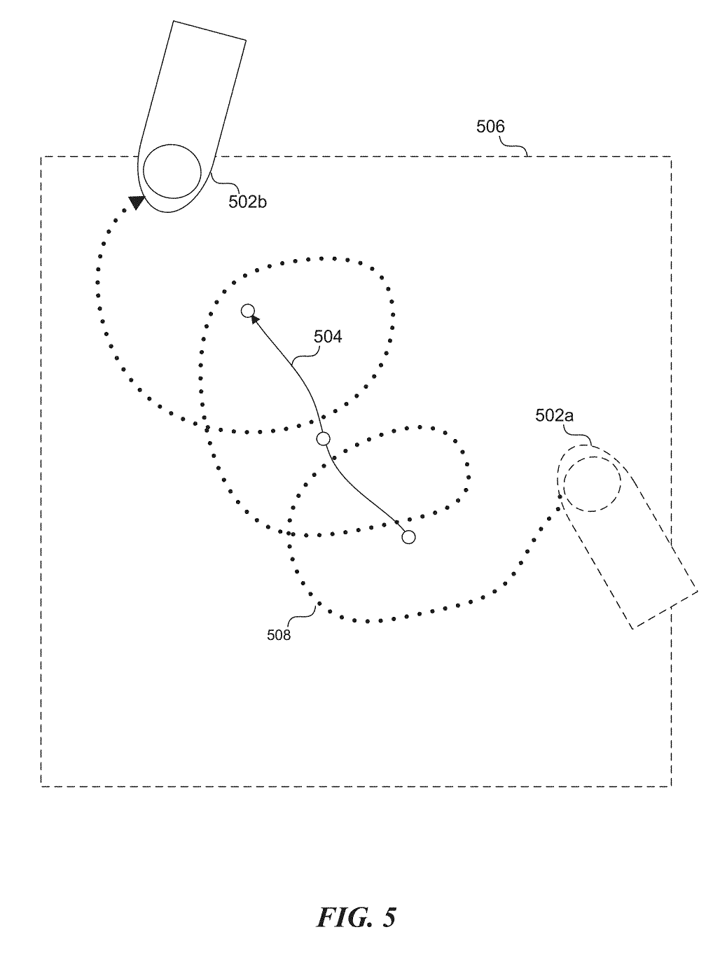

Implied geometry of a circular motion pattern can change over time based on tracked motion of an object (e.g., as user's finger). Consider, for example, the scenario depicted in FIG. 5. As shown in FIG. 5, a user has moved his or her finger over the surface of a touch screen display 506 from a first position 502a to a second position 502b. The resulting path 508 of the actual tracked motion of the user's finger is somewhat spiral-like, but clearly does not conform with an idealized spiral, such as the one depicted in FIG. 2. For example, as shown in FIG. 5, an implied origin of a spiral based on the motion of the user's finger proceeds across the display 506 along the path 504. In such an embodiment, the implied geometry of the circular motion pattern may be continually updated (e.g., at regular or irregular intervals) as the user's finger is tracked until the input gesture is complete (e.g., when the user lifts his or her finger off the display 506). Accordingly, the resulting control input (e.g., scrubbing rate) at any time during the user's input may depend on the position of the point of interaction (e.g., the user's finger) relative to an implied geometry (e.g., an implied origin) of the spiral at that given time.

In some embodiments, the scrubbing rate for a scrubbing operation based on a detected circular motion pattern may depend, at any given time, on a radial distance from the point of interaction to an implied origin of the circular motion pattern. FIG. 6A shows a diagram that illustrates how a radial distance varies at different points along an example circular motion pattern 600. In accordance with the circular motion pattern 600 of FIG. 6A, a scrubbing operation performed to control presentation of digital media content may have a first scrubbing rate, when the point of interaction 602a is at a first radial distance d1 from the implied origin 604 of the circular motion pattern 600, and a second scrubbing rate, when the point of interaction 602b is at a second radial distance d2 from the implied origin 604 of the circular motion pattern 600. For example, the point of interaction (e.g., a user's finger in contact with a touch screen) may be at a first position 602a relative to the implied origin 604 at time t0. Specifically, the user's finger may be in contact with the screen at a radial distance d1 from the implied origin 304. As the user moves his or her finger in a spiral-like manner towards the implied origin 604, the scrubbing rate may increase. Accordingly, when the user's finger is at position 602b at time t1, the scrubbing rate will be higher than it was at time t0 since the radial distance d2 is less than d1. In some embodiments, the inverse may be true. In other words, the scrubbing rate may decrease as the user moves his or her finger in a spiral-like motion towards the implied origin 604 of the circular motion pattern 600.

The manner in which the scrubbing rate increases or decreases may vary depending on the embodiment. For example, in some embodiments, the scrubbing rate may linearly depend on the radial distance between the point of interaction 602a-b and the implied origin 604 of the circular motion pattern 600. Alternatively, in some embodiments, the scrubbing rate and the radial distance between the point of interaction 602a-b and the implied origin 604 may exhibit some other type of relationship, such as an exponential or logarithmic relationship. For example, as the radial distance between the point of interaction 602a-b and the implied origin 604 decreases, the scrubbing rate may increase or decrease exponentially or logarithmically. A person having ordinary skill in the art will recognize that these are only examples of how a scrubbing rate (or any other presentation parameter) may depend on the radial distance between a point of interaction 602a-b and an implied origin 604 of a circular motion pattern 600. The actual configuration will depend on the requirements of a given implementation.

In some embodiments, the scrubbing rate applied at any given moment during a circular motion pattern may be determined based on a location of a point of interaction relative to one or more inferred circles. This represents an alternative way to conceptualize and calculate the scrubbing rate, but would otherwise result in a response similar to the previously described embodiment in FIG. 6A. This alternative conceptualization is described with respect to FIGS. 6B-6D. Specifically, FIG. 6B shows a set of multiple inferred circles 610, 612, 614. Each of the multiple inferred circles may be associated with a particular scrubbing rate. Consider, for example, an example involving a scrubbing operation applied to a movie that is roughly 2 hours in length. In this example, circular motion in a pattern roughly corresponding with the largest inferred circle 610 may apply a scrubbing operation that moves presentation of the movie forward or backward at a rate corresponding to one minute per revolution. Motion about smaller inferred circles may increase the scrubbing rate. For example, circular motion in a pattern roughly corresponding with the inferred circle 612 may apply a scrubbing operation that moves presentation of the movie forward or backward at a rate corresponding to five minutes per revolution. Further, circular motion in a pattern roughly corresponding with the inferred circle 614 may apply a scrubbing operation that moves presentation of the movie forward or backward at a rate corresponding to sixty minutes per revolution. The actual scrubbing rate for any given inferred circle may be context dependent. For example, in the context of a song that is two minutes long, circular motion in patterns roughly corresponding with the inferred circles 610, 612, and 614, may apply scrubbing operations that move presentation of the song forward or backward at a rates corresponding to one second per revolution, five seconds per revolution, and sixty seconds per revolution (respectively). As previously mentioned, the scrubbing rate may vary linearly or according to any other scale (e.g., a log scale).

In some embodiments, each of the multiple inferred circles 610, 612, and 614 may correspond with a predefined discrete scrubbing rate. In other words, the scrubbing rate may vary according to a step function. Alternatively, the scrubbing rate may be effectively “infinitely” variable. For example, consider the spiral motion pattern overlaid on the set of concentric inferred circles in FIG. 6C. In this example, points 620, 622, 624, 626, and 628 may correspond with scrubbing operations at rates corresponding to 1×, 3×, 5×, 10×, 30×, and 60× (respectively). In other words, the scrubbing rate will vary between the inferred circles depicted in FIG. 6C. The variation in scrubbing rate as a function of a radius of an inferred circle is visually depicted in the example graph of FIG. 6D. Note that the relationship between scrubbing rate and the radius of an inferred circle depicted in FIG. 6D is an example and not to be construed as limiting. As previously described the relationship may be linear or according to any other function (e.g., a log function).

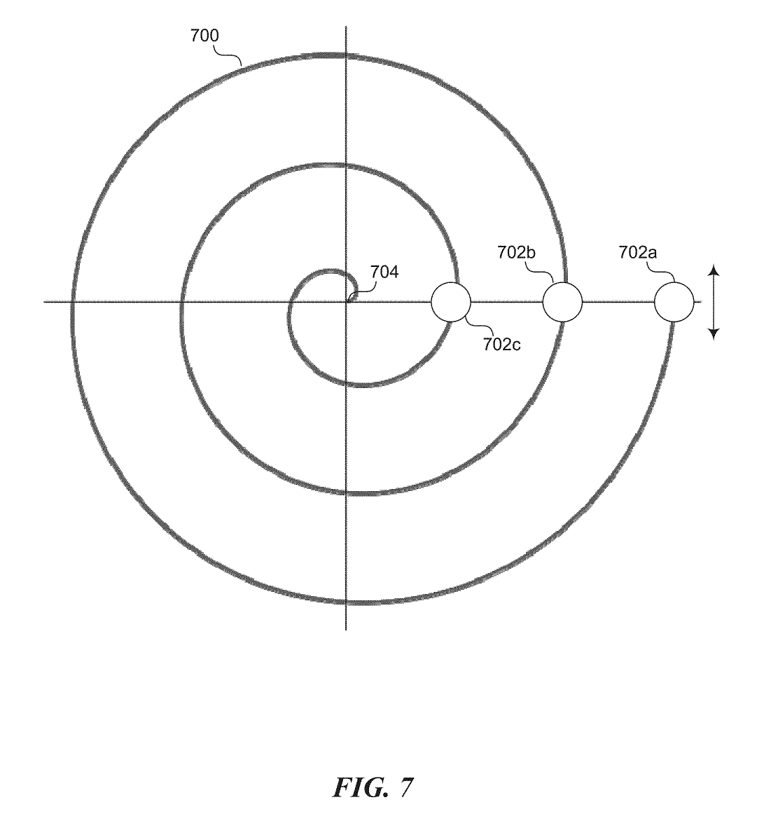

In some embodiments, the scrubbing rate for a scrubbing operation based on a detected circular motion pattern may depend, at any given time, on the number of revolutions about an implied origin of the circular motion pattern. Recall that a circular motion pattern may be based on the tracked motion of some object, such as a user's finger in contact with a touch screen display. The tracked path of motion on which the circular motion pattern is based may therefore revolve (at a constant radial distance or with widening or tightening curvature) about an implied origin of the circular motion pattern. FIG. 7 shows a diagram that illustrates how the tracked motion of a point of interaction may complete one or more revolutions about an implied origin of a circular motion pattern. In accordance with the circular motion pattern 700 of FIG. 7, a scrubbing operation performed to control presentation of digital media content may have a first scrubbing rate when the point of interaction 702a has not completed any revolutions about the implied origin 704, a second scrubbing rate when the point of interaction 702b has completed one revolution about the implied origin 704, a third scrubbing rate when the point of interaction 702c has completed two revolutions about the implied origin 704, and so on.

Consider again an example in which the point of interaction 702a-c represents a point of contact between a user's finger and a touch screen display. In such an embodiment, as the user moves his or her finger over the touch screen in a circular motion, the scrubbing rate of a resulting scrubbing operation performed on the piece of digital media content will increase (or decrease) as the user's finger completes revolutions about an implied origin of a circular motion pattern. Again, the implied origin may not be a fixed point relative to the display screen. As described with respect to FIG. 5, the implied origin of the circular motion pattern may proceed across the screen over time based on the actual tracked motion of the user's finger. For example, the actual tracked motion 508 of the user's finger depicted in FIG. 5 may represent several revolutions about an implied origin of a circular motion pattern that is proceeding along path 504 even though relative to the display screen 506, the actual tracked path 508 does not appear to conform with a circular motion pattern.

Returning to FIG. 7, the manner in which the scrubbing rate increases or decreases may vary depending on the embodiment. In some embodiments, the scrubbing rate may linearly depend on the number of revolutions of the point of interaction 702a-c about an implied origin point 704 of the circular motion pattern 700. Alternatively, in some embodiments, the scrubbing rate and the number of revolutions of the point of interaction 702a-c about the implied origin 704 of the circular motion pattern 700 may exhibit some other type of relationship such as an exponential or logarithmic relationship. For example, as the point of interaction 702a-c completes revolutions about the implied origin 704 of the circular motion pattern 700, the scrubbing rate may increase or decrease exponentially or logarithmically. A person having ordinary skill in the art will recognize that these are only examples of how a scrubbing rate (or any other presentation parameter) may depend on the number of revolutions of a point of interaction 702a-c about an implied origin 704 of a circular motion pattern 700. The actual configuration will depend on the requirements of a given implementation.

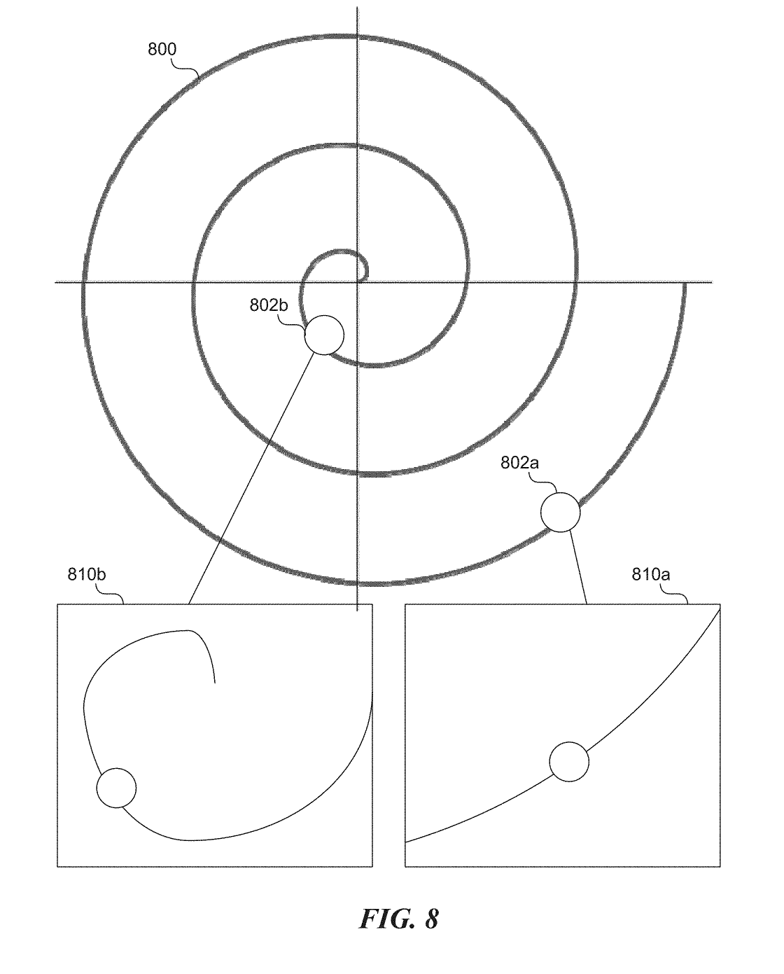

In some embodiments, the scrubbing rate for a scrubbing operation based on a detected circular motion pattern may depend, at any given time, on characteristics of the tracked motion of a point of interaction. Again, a circular motion pattern may be based on the tracked motion of some object, such as a user's finger, in contact with a touch screen display. As a user moves his or her finger over the surface of the display in a circular pattern, certain characteristics such as the curvature of the tracked motion may vary. Accordingly, an interface can be configured in which the scrubbing rate for a scrubbing rate operation varies based on a characteristic such as curvature of the tracked motion of the user's finger at any given time. FIG. 8 shows a diagram that illustrates how the curvature of the path of motion of a point of interaction varies along a circular motion pattern (specifically, a spiral motion pattern). As shown in FIG. 8, a tracked path of motion at a first point of interaction 802a (e.g., at time t0) may exhibit a first curvature (e.g., as suggested in detail 810a) while the tracked path of motion at a second point of interaction 802b (e.g., at time t1) may exhibit a second curvature (e.g., as suggested in detail 810b). The scenario depicted in FIG. 8 may represent a user's finger moving in a circular motion pattern from a first position 802a at time t0 to a second position 802b at time t1. Due to the characteristics of the circular motion pattern 800, the resulting curvature of the path of motion is greater at time t1 than it is at time t0. The calculated curvature at any given point may be an instantaneous curvature or may be an aggregation (e.g., minimum, maximum, average, etc.) of several curvature calculations over a period of time.

The manner in which the scrubbing rate increases or decreases may vary depending on the embodiment. In some embodiments, the scrubbing rate may linearly depend on a calculated curvature of a path of motion at a point of interaction. Alternatively, in some embodiments, the scrubbing rate may increase or decrease exponentially or logarithmically based on the calculated curvature of a path of motion at a point of interaction. A person having ordinary skill in the art will recognize that these are only examples of how a scrubbing rate (or any other presentation parameter) may depend on a calculated curvature of a path of motion at a point of interaction. The actual configuration will depend on the requirements of a given implementation.

### Example Implementations of User Interaction Based on Circular Motion Patterns

FIG. 9 shows an example implementation of the disclosed user interaction technique based on circular motion patterns at an electronic device in the form of a touch screen display device 900, such as a tablet device or smart phone. In the example implementation depicted in FIG. 9, a video 930 is being displayed via a touch-sensitive display 910 of the electronic device 900. To perform a scrubbing operation to move forward or backward in the video 930, a user can input a circular motion pattern gesture via touch-sensitive display 910. For example, as shown in FIG. 9, a scrubbing operation is performed in response to the user contacting the touch-sensitive display 910 with his or her finger 902 and, while maintaining contact, moving his or her finger 902 in a circular motion pattern 908. As previously discussed, the scrubbing rate of the scrubbing operation may depend on the geometry of the circular motion pattern.

Note that the user need not interact with any designated interactive GUI element, such as an adjustable scrubbing button or wheel, to perform the scrubbing operation. In the embodiment illustrated in FIG. 9, the user can perform the scrubbing operation by moving his or her finger 902 in the circular motion pattern 908 anywhere (or nearly anywhere) on the touch-sensitive display 910. Alternatively, in some embodiments, certain portions of the touch-sensitive display 910 (e.g., portions corresponding to the displayed video 930) may be designated to receive the circular motion pattern input. Again, interpretation of received gestures may be context dependent. A similar touch gesture applied while displaying other types of content may result in a different operation or no effect.

In some embodiments, other outputs (e.g., visual, audible, tactile, etc.) may be presented to the user in response to the detected circular motion pattern. For example, as depicted in FIG. 9, performance of the scrubbing operation in response to the user's interaction may cause the display of a dynamic preview element 950 which shows a preview of a current frame of the video as the scrubbing operation is in progress. Such a feature may be particularly suited to streaming video in which displaying the actual frames at a rate based on the scrubbing operation is impractical.

In some embodiments, audible outputs may be presented via speakers (900) of device 900 in response to the user inputting a touch gesture. An illustrative example includes outputting a continual clicking sound as the user moves his or her finger in the circular motion pattern to provide affirmative feedback that they are performing a scrubbing operation.

In some embodiments, tactile outputs (e.g., vibrations, electrical output, etc.) may be output via a touch-sensitive display 910 that is equipped for haptic feedback. An illustrative example includes presenting a tactile output (e.g., a perceptible bump or vibration) via the display 910 each time a particular portion (e.g., scene, chapter, page, song, chorus section, etc.) of the digital media content is passed during a scrubbing operation. Consider, for example, presentation of a long audio book. A tactile output may be presented to the user via his or her finger each time a chapter is passed in the audio book as they perform a scrubbing operation to fast forward through the audio book. As another illustrative example, a tactile output may be presented to the user via his or her finger each time the scene changes in a video as they perform a scrubbing operation for fast forward through the video.

The user interaction depicted in FIG. 9 has been described in the context of a scrubbing operation; however, as previously discussed, a similar user interaction may be applied to control other aspects of the presentation of the video 930. For example, a user moving his or her finger 902 in the motion pattern 908 may adjust the volume of audio output associated with the video. As another example, a user moving his or her finger 902 in the motion pattern 908 may cycle through a graphical listing of multiple videos stored at the device 900 or accessible via a computer network.

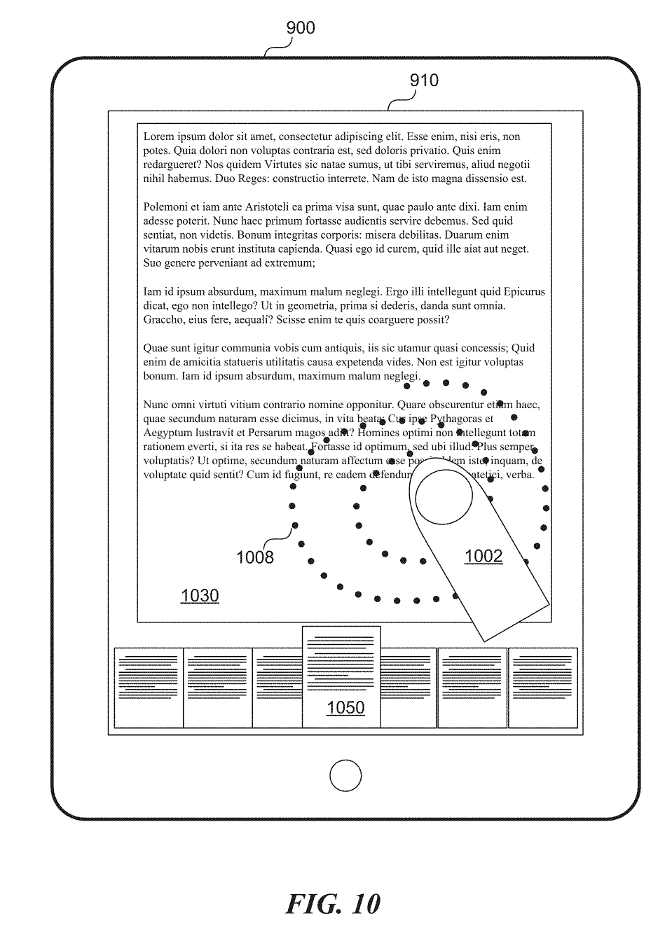

FIG. 10 shows an example implementation similar to that disclosed in FIG. 9 except that the disclosed user interaction technique is applied to perform a scrubbing operation with respect to a displayed document. In the example implementation depicted in FIG. 10, a document 1030 (e.g., a multi-page .pdf document) is being displayed via the touch-sensitive display 910 of the electronic device 900. To perform a scrubbing operation to move forward or backward through the pages of the document 1030, a user can input a circular motion pattern gesture via the touch-sensitive display 910. For example, as shown in FIG. 10, a scrubbing operation is performed in response to the user contacting the touch-sensitive display 910 with his or her finger 1002 and, while maintaining contact, moving his or her finger 1002 in a circular motion pattern 1008. As previously discussed, the scrubbing rate of the scrubbing operation may depend on the geometry of the circular motion pattern. Similar to as described with respect to the example implementation of FIG. 9, a visual output in the form of a dynamic preview 1050 element may be presented to the user via the display 901 as the user performs the scrubbing operation to move through the pages of the document. The dynamic preview element 1050 may display a preview of the current page at any time during the scrubbing operation.

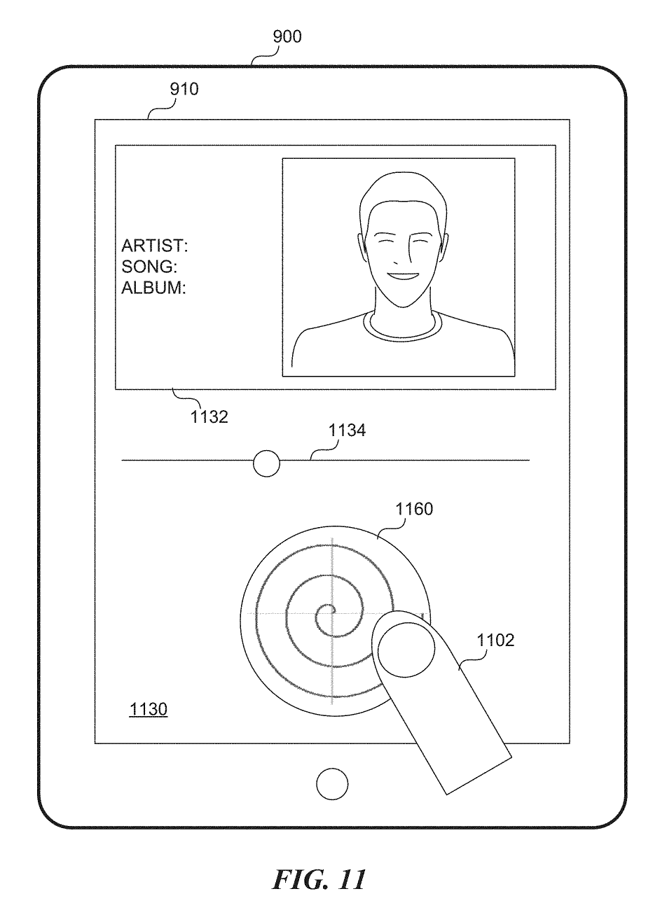

As previously alluded to, a user need not interact with a designated GUI element, such as an adjustable scrubbing button or wheel, to perform a scrubbing operation. However, in some situations, interaction via a GUI element may be preferable. FIG. 11 shows an example implementation similar to that disclosed in FIG. 9 except that the disclosed user interaction technique is applied via an interactive GUI element 1160 to perform a scrubbing operation. In the example implementation depicted in FIG. 11, a GUI 1130 associated with a music application is displayed via the touch-sensitive display 910 of the electronic device 900. The GUI 1130 may be displayed to the user while the device is playing a song via speakers (not shown) of the device 900. The GUI 1130, in this example, includes standard music application features, such as information 1132 regarding the song being played and a progress bar 1134 indicating a playback progress of the song. The example GUI 1130 also includes an interactive element 1160 through which to control a scrubbing operation in accordance with the disclosed user interaction technique. For example, in an embodiment, the interactive element is merely a visually-indicated (e.g., by a circle) region of GUI 1130 that is receptive to a touch-based circular motion pattern. In other embodiments, the interactive element 1160 may include animated visuals indicative of the scrubbing operation performed by the user. For example, the interactive element 1160 may depict a representation of a physical element such as a rotatable knob. Further the rotatable knob, represented by element 1160, may rotate at a rate corresponding with the scrubbing rate at any given moment during a scrubbing operation. For example, as the user's finger moves in a circular motion pattern over the surface of display 910, the rate of rotation of the knob, represented by element 1160, may increase (or decrease) to correspond with the scrubbing rate of the scrubbing operation resulting from the user's input.

The disclosed user interaction technique can also be implemented without a touch screen device. FIG. 12 shows an example implementation of the disclosed user interaction technique in which a circular motion pattern is “drawn” in the air. In the example implementation depicted in FIG. 12, a video 1230 is being displayed via a display device 1210. The display device 1210 may be a wall mounted television. Alternatively the video 1230 may be displayed on the wall by a projector device (not shown). To perform a scrubbing operation to move forward or backward in the video 1230, a user 1203 can input a circular motion pattern gesture by moving an object through the air in a circular motion 1208. For example, as indicated in FIG. 12, a user may simply move his or her finger through the air as indicated by the motion path 1208.

A stationary sensing device (not shown) located in the vicinity of the user may detect and track the motion of the user's 1203 finger, interpret the motion, and recognize the motion as a circular motion pattern associated with an input such as scrubbing operation input. The sensing device may include various sensors for detecting and tracking the motion of the user's 1203 finger. For example, the stationary sensing device may include optical sensors to capture images of the user 1203 that are then analyzed using computer vision techniques to detect and track the motion of an object such as the user's 1203 finger. An example of such as sensing device is the Microsoft Kinect™. In some embodiments, the user 1203 may hold a passive hand-held wand or light source (not shown) that is specifically recognizable to the stationary sensing device.

In any case, the stationary sensing device may be configured to detect and track the motion of the object (e.g., the user's finger) along motion path 1208 and, in some cases, interpret the motion as a scrubbing operation (or an input adjusting some other presentation parameter). The sensing device might then transmit the recognized input (via a wired or wireless communication channel) to a display device presenting the digital media content (e.g., video 1230) to control a scrubbing operation. Alternatively, in some embodiments, the sensing device may simply capture motion data and transmit the motion data to another electronic device (e.g., a computer, television, game console, etc.) channel for analysis. The other electronic device may then interpret the received motion data as an input (e.g., a scrubbing operation) and control presentation of the digital media content (e.g., the video 1230) accordingly. In some embodiments, any one or more of the sensing device, display device, and the device interpreting the motion data may be integrated as a single electronic device.

In some embodiments, motion may be sensed using a hand-held sensing device. For example, the user 1203 may alternatively input the circular motion pattern by moving a sensing device through the air along the motion path 1208. An example sensing device might include a specialized controller device such as a Nintendo Wii™ remote or a general purpose device with motion sensing capabilities such as smart phone equipped with accelerometers. In any case, the hand-held sensing device may be configured to detect and track the motion along motion path 1208 and, in some cases, interpret the motion as a scrubbing operation (or an input adjusting some other presentation parameter). The hand-held sensing device might then transmit the recognized input via a wireless communication channel (e.g., Bluetooth, Wi-Fi, etc.) to a display device presenting the digital media content (e.g., video 1230). Alternatively, in some embodiments, the handheld sensing device may simply capture motion data and transmit the motion data to another electronic device (e.g., a computer, television, game console, etc.) via a wireless communication channel for analysis. The other electronic device may then interpret the received motion data as an input (e.g., a scrubbing operation) and control presentation of the digital media content (e.g., the video 1230) accordingly.

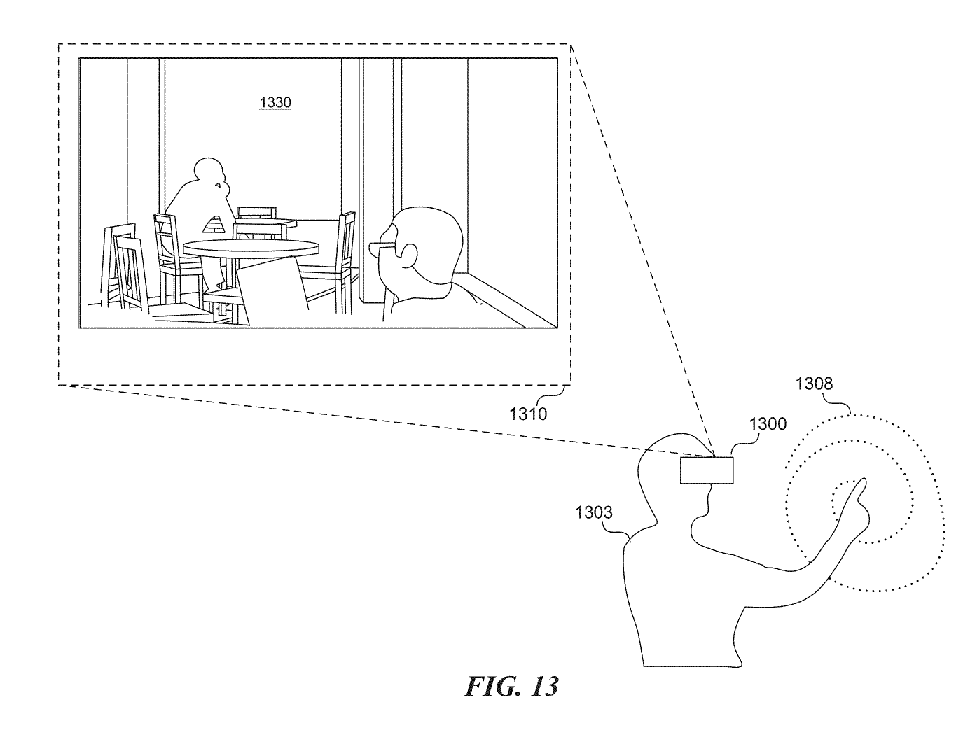

FIG. 13 shows an example implementation of the disclosed user interaction technique similar to that shown in FIG. 12 expect that the digital media content is presented via a wearable device 1300. Specifically, the wearable device 1300 is depicted in FIG. 13 as a head-mounted AR or VR device. As shown in detail 1310, digital media content such as a video 1330 is displayed via the head-mounted AR or VR device. To perform a scrubbing operation (or any other type of input) a user 1303 may input a circular motion pattern gesture by moving an object though the air. For example, as indicated in FIG. 13, a user 1303 may simply move his or her finger through the air as indicated by the motion path 1308. The motion of the object along the path 1308 can be detected and tracked using similar techniques as described with respect to the implementation of FIG. 12.

### Example Processes for User Interaction Based on Circular Motion Patterns

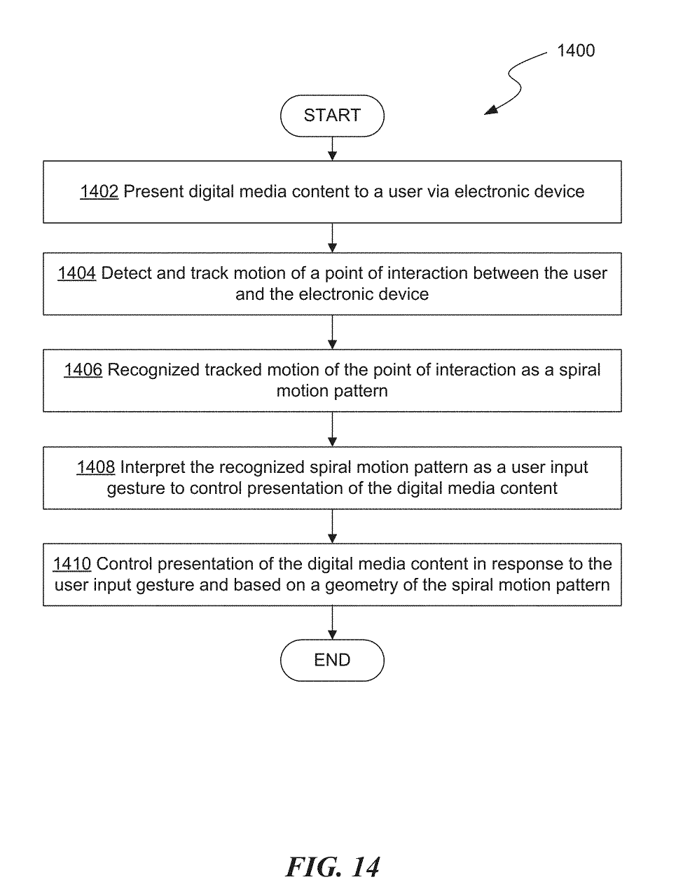

FIG. 14 is a flow chart of an example process 1400 for controlling presentation of digital media content at an electronic device using the disclosed user interaction technique. One or more steps of the example process 1400 may be performed by any one or more of the components of the example processing system 100 described with respect to FIG. 1. For example, the process depicted in FIG. 14 may be represented in instructions stored in memory that are then executed by a processing unit associated with an electronic device. The process 1400 described with respect to FIG. 14 is an example provided for illustrative purposes and is not to be construed as limiting. Other processes may include more or fewer steps than depicted while remaining within the scope of the present disclosure. Further, the steps depicted in the flow chart of FIG. 14 may be performed in a different order than is shown.

The example process 1400 begins at step 1402 with presenting the digital media content to a user via an output device associated with an electronic device. The output device may include a display device, speakers, a tactile feedback device, or any other type of device configured to generate a human-perceptible output based on the digital media content. For example, presentation of the digital media content may include display of a visual output (e.g., images, video, graphics, etc.) based on the digital media content via the display device, and audio output via the speakers, or a tactile output via a tactile feedback device.

The example process 1400 continues at step 1404 with detecting a user interaction with the electronic device by detecting and tracking a motion of a point of interaction between the user and the electronic device. As previously discussed, the point of interaction in some cases may be a point of contact between an object such as the user's finger or a stylus and a touch-sensitive surface such as a touch-sensitive display associated with the electronic device. In such an embodiment, tracking the motion of the point of interaction may include detecting a point of contact between the object and a touch-sensitive surface, defining the point of interaction as the detected point of contact, and tracking the motion of the point of contact across the touch-sensitive surface.

In other embodiments, the point of interaction may be a position of an object in motion relative to the electronic device, for example, as described with respect to FIGS. 12-13. In such embodiments, the motion of the point of interaction may be detected and tracked using various sensor devices. For example, in an embodiment, tracking the motion of the point of interaction includes capturing images of an object using an image capture device associated with the electronic device, determining a position of the object relative to the electronic device by applying a computer vision process to the captured images, defining the point of interaction as the detected position of the object, and tracking the motion of the object based on changes in the determined position of the object over time. Alternatively, or in addition, tracking the motion of the point of interaction may include receiving sensor data from a motion sensor coupled to the object (e.g., via a wireless communication channel), determining a position of the object based on the received sensor data, defining the point of interaction as the detected position of the object, and tracking the motion of the object based on changes in the determined position of the object over time.

The example process 1400 continues at step 1406 with recognizing the tracked motion of the object as a circular motion pattern. As previously discussed with respect to FIG. 3, the actual tracked motion of the point of interaction will rarely follow the path of an ideal mathematical circle or spiral due to the imprecise nature of user input motion. Accordingly, step 1406 may include analyzing the tracked motion of the point of interaction and matching, based on a heuristic classifier, the tracked motion to any one or more predefined models that describe circular motion. In some embodiments, this process may include applying machine learning to more effectively recognize tracked motion as a circular motion pattern. Further, as described with respect to FIG. 4, the step of recognizing the tracked motion as a circular motion pattern may be performed early in the tracked motion of the point of interaction, for example, based on a detected curvature in the tracked motion.

The example process 1400 continues at step 1408 interpreting the circular motion pattern as a user input gesture to control presentation of the digital media content. As previously discussed, controlling presentation of the digital media content may include performing a scrubbing operation or adjusting some other variable parameter such as the volume, picture quality, etc. associated with the presentation of the digital media content.

The example process 1400 continues at step 1410 with controlling presentation of the digital media content at the electronic device in response to the user input gesture. In the case of some variable parameter associated with presentation of the digital media content, the process of controlling the digital media content may include adjusting a value of the variable parameter in response to the user input gesture. For example, in response to a user input circular motion gesture, a volume of audio output can be adjusted. In the specific case of a scrubbing operation, the step of controlling presentation of the digital media content may include moving from a first position to a second position in the presentation of the digital media content.

The process of moving from a first position to a second position in the presentation of the digital media content will depend on the type of digital media content presented. For example, moving from a first position to a second position in the presentation of the digital media content can include moving from a first audio playback position to a second audio playback position in an audio file presented using a speaker associated with the electronic device, moving from a first video playback position to a second video playback position in a video displayed using a display device associated with the electronic device, moving from a first page to a second page in a document displayed using the display device associated with the electronic device, moving from a first image to a second image in an album of a plurality of images displayed using the display device associated with the electronic device, and the like.

The manner in which the step of controlling presentation of the digital media content at the electronic device will depend on the characteristics of the circular motion pattern of the user input gesture, specifically, the geometry of the circular motion pattern. For example, as the point of interaction revolves about an implied origin of the circular motion pattern, the rate of adjusting a variable parameter (e.g., volume) associated with the presentation of the digital media content may increase or decrease. In the specific case of a scrubbing operation, a variable scrubbing rate associated with the scrubbing operation may increase or decrease (e.g., linearly, exponentially, logarithmically, etc.).

In some embodiments, the variable scrubbing rate is based on a radial distance between the point of interaction (e.g., an object) and a point of reference such as an implied origin point of the circular motion pattern at any given time during the user input gesture. For example, in an embodiment, the variable scrubbing rate increases as the radial distance between point of interaction and the implied origin point of the circular motion pattern decreases. Conversely, the variable scrubbing rate may decrease as the radial distance between the point of interaction and the implied origin point of the circular motion pattern increases.

In some embodiments, the variable scrubbing rate is based on a curvature in the motion of the point of interaction at any given time during the user input gesture. For example, in an embodiment, the variable scrubbing rate increases as the curvature in the motion of the object increases. Conversely, the variable scrubbing rate may decrease as the curvature in the motion of the object decreases.

In some embodiments, the variable scrubbing rate is based on a tracked number of revolutions in the motion of the point of interaction about a point of reference such as an implied origin point of the circular motion pattern at any given time during the user input gesture. For example, in an embodiment, the variable scrubbing rate increases as a tracked number of revolutions increases.

What is claimed is:

1. A method for controlling presentation of media content at an electronic device, the method comprising:
detecting a user interaction with the electronic device by tracking a motion of an object relative to the electronic device;
recognizing the tracked motion of the object as a circular motion pattern;
interpreting the circular motion pattern as a scrubbing input; and
controlling presentation of the media content at the electronic device in response to the scrubbing input by moving from a first position to a second position in the media content at a variable scrubbing rate, the variable scrubbing rate based on a geometry of the circular motion pattern.

2. The method of claim 1, wherein the variable scrubbing rate is based on a radial distance between the object and an implied origin point of the circular motion pattern at a particular time.

3. The method of claim 2, wherein the variable scrubbing rate increases as the radial distance between the object and the implied origin point of the circular motion pattern decreases, and wherein the variable scrubbing rate decreases as the radial distance between the object and the implied origin point of the circular motion pattern increases.

4. The method of claim 1, wherein the variable scrubbing rate is based on a curvature in the motion of the object at a particular time.

5. The method of claim 4, wherein the variable scrubbing rate increases as the curvature in the motion of the object increases, and wherein the variable scrubbing rate decreases as the curvature in the motion of the object decreases.

6. The method of claim 1, wherein the variable scrubbing rate is based on a tracked number of revolutions in the motion of the object about an implied origin point of the circular motion pattern at a particular time.

7. The method of claim 6, wherein the variable scrubbing rate increases as the tracked number of revolutions increase.

8. The method of claim 1, wherein the variable scrubbing rate increases and/or decreases according to a logarithmic scale.

9. The method of claim 1, wherein the circular motion pattern is spiral motion pattern.

10. The method of claim 9, wherein the spiral motion pattern is based on an Archimedean spiral.

11. The method of claim 1, wherein the object is any of a finger of a user, a stylus, or a motion sensing device.

12. The method of claim 1, wherein tracking the motion of the object relative to the electronic device includes:
detecting a contact between the object and a touch-sensitive surface of the electronic device; and
tracking a motion of the contact across the touch-sensitive surface of the electronic device.

13. The method of claim 1, wherein tracking the motion of the object relative to the electronic device includes:
capturing images of the object by the electronic device; and
tracking the motion of the object in the captured images.

14. The method of claim 1, wherein tracking the motion of the object is based on motion sensor data from a motion sensing device.

15. The method of claim 1, wherein a position of an implied origin point of the circular motion pattern changes over time based on the tracked motion of the object.

16. The method of claim 1, wherein the media content includes any of an audio file, an image file, a video file, or a document.

17. An apparatus for controlling presentation of digital media content the system comprising:
an output device configured to output a presentation of the digital media content to a user;
a motion sensing device configured to detect and track a motion of an object; and
a processor coupled to the motion sensing device and the output device, the processor configured to:
recognize the tracked motion of the object as a circular motion pattern;
interpret the circular motion pattern as a user input to control presentation of the digital media content; and
control the presentation of the digital media content via the output device based on a geometry of the circular motion pattern of the user input.

18. The apparatus of claim 17, wherein the circular motion pattern is spiral motion pattern.

19. The apparatus of claim 17, wherein controlling presentation of the digital media content via the output device includes performing a scrubbing operation to move the presentation of the digital media content from a first position to a second position in the digital media content.

20. The apparatus of claim 19, wherein the scrubbing operation has a variable scrubbing rate based on the geometry of the circular motion pattern.

21. The apparatus of claim 20, wherein at any time during the tracked motion of the object, the variable scrubbing rate is based any of:
a radial distance between the tracked object and an implied origin point of the circular motion pattern;
a curvature of the tracked motion of the object; or
a number of revolutions in the tracked motion of the object about the implied origin point of the circular motion pattern.

22. The apparatus of claim 20, wherein the variable scrubbing rate increases and/or decreases based on the geometry of the circular motion pattern according to a logarithmic scale.

23. The apparatus of claim 17, wherein controlling presenting of the digital media content via the output device includes adjusting a volume of audio associated with the digital media content, wherein a rate of adjusting the volume is based on the geometry of the circular motion pattern.

24. The apparatus of claim 17, wherein the object is any of a finger of the user, a stylus, or a motion sensing device.

25. The apparatus of claim 17, wherein the output device is a display device and wherein presenting the digital media content includes displaying a visual output of the digital media content via the display device.

26. The apparatus of claim 25, wherein the motion sensing device is integrated with the display device as a touch-sensitive display system.

27. The apparatus of claim 17, wherein the output device is a speaker and wherein presenting the digital media content includes outputting audio associated with the digital media content via the speaker.

28. The apparatus of claim 17, wherein the motion sensing device is an image capture device configured to capture images of the object, wherein the motion of the object is detected and tracked based on analysis of the captured images using a computer vision process.

29. The apparatus of claim 17, wherein the digital media content includes any of an audio file, an image file, a video file, or a document.

30. A method for performing a scrubbing operation during presentation of digital media content at an electronic device, the method comprising;
detecting and tracking motion of a point of interaction with the electronic device;
recognizing the tracked motion of the point of interaction as a circular motion pattern about a point of reference;
interpreting the tracked motion of the point of interaction in the circular motion pattern as a user input gesture indicative of a request to perform the scrubbing operation;
performing the scrubbing operation to move from a first position to a second position in the presentation of the digital media content at a variable scrubbing rate in response to the user input gesture; and
adjusting the variable scrubbing rate, while performing the scrubbing operation, as the tracked motion of the point of interaction moves inward with gradually tightening curvature towards the point of reference or moves outward with gradually widening curvature away from the point of reference.

31. The method of claim 30, wherein the circular motion pattern is spiral motion pattern.

32. The method of claim 30, adjusting the variable scrubbing rate includes:
increasing the variable scrubbing rate as the tracked motion of the point of interaction moves inward towards the point of reference; or
decreasing the variable scrubbing rate as the tracked motion of the point of interaction moves outward with gradually widening curvature away from the point of reference.

33. The method of claim 30, wherein the variable scrubbing rate increases or decreases according to a logarithmic scale.

34. The method of claim 30, wherein at any time during the tracked motion of the point of interaction, the variable scrubbing rate is based any of:
a radial distance between the point of interaction and the point of reference;
a curvature of the tracked motion of the point of interaction; or
a number of revolutions in the tracked motion of point of interaction about the point of reference.

35. The method of claim 30, wherein the point of reference is an implied origin of the circular motion pattern.

36. The method of claim 35, wherein a location of the implied origin point of the circular motion pattern relative to the electronic device changes over time based on the tracked motion of the point of interaction.

37. The method of claim 30, wherein the tracked motion of the point of interaction corresponds with a tracked motion of an object relative to the electronic device.

38. The method of claim 30, wherein the point of interaction is a point of contact between an object and a touch-sensitive input device associated with the electronic device, the object including any of a finger or a stylus.

39. The method of claim 30, wherein the tracking the motion of the point of interaction includes:
detecting a point of contact between an object and a touch-sensitive surface of the electronic device;
defining the point of interaction as the detected point of contact; and
tracking a motion of the point of contact across the touch-sensitive surface of the electronic device.

40. The method of claim 30, wherein the tracking the motion of the point of interaction includes:
capturing images of an object using an image capture device associated with the electronic device;
determining a position of the object relative to the electronic device by applying a computer vision process to the captured images;
defining the point of interaction as the detected position of the object; and
tracking the motion of the object based on changes in the determined position of the object over time.

41. The method of claim 30, wherein moving from a first position to a second position in the presentation of the digital media content includes any of:
moving from a first audio playback position to a second audio playback position in an audio file presented using a speaker associated with the electronic device;
moving from a first video playback position to a second video playback position in a video displayed using a display device associated with the electronic device;
moving from a first page to a second page in a document displayed using the display device associated with the electronic device; or
moving from a first image to a second image in an album of a plurality of images displayed using the display device associated with the electronic device.

42. A system for controlling presentation of digital media content, the system comprising:
a display device configured to output a visual presentation of the digital media content to a user;
a speaker configured to output an audible presentation of the digital content to the user;
a motion sensing device;
a processor; and
a memory having instructions stored thereon, which when executed by the processor, cause the system to:
present the digital media content using the display device and/or speaker; and
while presenting the digital media content:
receive sensor data from the motion sensing device;
detect and track motion of a point of interaction between the user and the system;
recognize the tracked motion of the point of interaction as a circular motion pattern about a point of reference;
interpret the tracked motion of the point of interaction in the circular motion pattern as a user input gesture indicative of a request to perform a scrubbing operation;
perform the scrubbing operation to move from a first position to a second position in the visual and/or audible presentation of the digital media content at a variable scrubbing rate in response to the user input gesture; and
adjust the variable scrubbing rate, while performing the scrubbing operation, as the tracked motion of the point of interaction moves inward with gradually tightening curvature towards the point of reference or moves outward with gradually widening curvature away from the point of reference.
